(19) United States
(12) Patent Application Publication
(10) Pub. No.: US 2004/0231648 A1
(43) Pub. Date: Nov. 25, 2004

(54) Fuel cooling system for fuel system

(76) Inventor: Goichi Katayama, Hamamatsu-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 10/848,702

(22) Filed: May 19, 2004

(30) Foreign Application Priority Data
May 19, 2003 (JP) 2003-140077

(51) Int. Cl. F02M 15/00

(52) U.S. Cl. 123/541

(57) ABSTRACT

A watercraft engine fuel cooling system that cools a fuel vapor separator through a detachable heat exchanger. The detachable heat exchanger allows for inexpensive replacement of the detachable heat exchanger if the heat exchanger should become damaged from corrosion. The detachable heat exchanger can transfer the heat from the vapor separator through a water cooling jacket, a thermoelectric element, or through fins to the surrounding air. The transfer of heat from the fuel vapor separator allows the fuel to be kept within a predetermined fuel temperature range.

### PRIORITY INFORMATION

This application is based on and claims priority to Japanese Patent Application No. 2003-140077, filed May 19, 2003, the entire contents of which is hereby expressly incorporated by reference.

### BACKGROUND OF THE INVENTIONS

1. Field of the Inventions

The present inventions relate generally to a fuel cooling system for an outboard motor, and more particularly to a detachable fuel cooling system for a vapor separator.

2. Description of the Related Art

In the interest of improving engine performance and particularly fuel efficiency and exhaust emission control, many types of engines now employ a fuel injection system for supplying fuel to the engine. In these systems, fuel usually is injected into an air induction device by a fuel injector. This type of fuel injection has the advantages of permitting the amount of fuel delivered for each cycle of the engine to be precisely adjusted. In addition, by utilizing the fuel injection system, it is possible to maintain the desired fuel air ratio under a wide variety of engine running condition.

An amount of the fuel injected by the fuel injector is usually controlled by a control device in response to the engine running conditions. The fuel is delivered to the fuel injector by a fuel pump under a certain fixed pressure and the duration for injection per unit time, i.e., a duty ratio, is controlled by the control device so that any required amount can be metered. Strict control of the fuel amount is quite important for stable operations of the engine.

Some engines for outboard motors employ such a fuel injection system. The fuel injection system generally includes, other than the fuel injector, a main fuel tank disposed on a hull of the associated watercraft for storing fuel and a fuel reservoir attached on the engine for temporarily storing the fuel. The fuel in the main fuel tank is supplied to the fuel reservoir through a fuel supply conduit and the fuel in the fuel reservoir, in turn, is delivered to the fuel injector through another fuel supply conduit. The excess fuel that has not been injected by the fuel injector is returned to the fuel reservoir through a return conduit.

The engine is, due to being employed for outboard motors, operated quite often in a high speed and high load. The engine, thus, produces much heat under this running condition. In addition, the engine is generally enclosed in a protective cowling assembly and the heat accumulates within the cowling. The ambient air around the engine, as a matter of course, is heated. The fuel supply conduits, at least in part, and the fuel return conduit extend within the protective cowling assembly and thus tend to absorb some heat from the engine.

Under some circumstances, bubbles or vapor can be formed in the fuel and interfere and degrade the strict control of the fuel amount injected during each duty cycle. Vapor lock may even occur in the fuel supply and/or fuel return conduits. If this happens, the fuel is no longer be supplied or returned to the fuel injector or fuel reservoir and the engine consequently stalls.

### SUMMARY OF THE INVENTIONS

Watercraft engines typically incorporate an engine cooling system and a fuel system that includes a vapor separator. Within the engine cooling system is commonly a cooling subsystem that cools the vapor separator. Due to the heat generated by the engine and the compact environment of watercraft engine compartments, a vapor separator cooler can be used to keep the fuel within a predetermined fuel temperature.

Using a cooling system to cool the vapor separator can lead to corrosion and an eventual replacement of the entire vapor separator. Replacement of the entire vapor separator can be costly, inconvenient, and time consuming.

One aspect of at least one of the inventions disclosed herein includes the realization that certain problems associated with corrosion of a vapor separator caused by water-cooling can be overcome by forming the cooling jacket separate from the vapor separator and connecting the separate pieces for thermal communication during operation. For example, a cooling jacket for the vapor separator can be formed of a heat exchanger device with at least one surface configured to thermally communicate with an outer surface of the vapor separator. As such, the pieces of the vapor separator and the cooling jacket can be disassembled and cleaned, thereby allowing the removal and monitoring of corrosion.

In accordance with an embodiment of at least one of the inventions disclosed herein, an engine comprises an engine body defining at least one combustion chamber. A fuel system is configured to provide fuel for combustion in the combustion chamber, the fuel system including a vapor separator. Additionally, a heat exchanger is disposed in thermal communication with the vapor separator and configured to be detachable from the vapor separator.

In accordance with another embodiment of at least one of the inventions disclosed herein, a watercraft propulsion system comprises an engine including an engine body defining at least one combustion chamber. A fuel system includes a vapor separator, the vapor separator including a vapor separator tank. Additionally, a detachable heat exchanger includes a heat exchanger cooling system configured to transfer heat away from the vapor separator tank.

In accordance with a further embodiment of at least one of the inventions disclosed herein, an engine comprises an engine body defining at least one combustion chamber. A fuel system is configured to provide fuel for combustion in the combustion chamber, the fuel system including a vapor separator. Additionally, a heat exchanger is disposed in thermal communication with the vapor separator, the heat exchanger including means for detaching the heat exchanger from the vapor separator.

### BRIEF DESCRIPTION OF THE DRAWINGS

The foregoing features, aspects, and advantages of the present inventions will now be described with reference to the drawings of a preferred embodiment that is intended to illustrate and not to limit the inventions. The drawings comprise nine figures in which:

FIG. 1 is a side elevational view of an outboard motor configured in accordance with a preferred embodiment, with an associated watercraft partially shown in section;

FIG. 2 is a top view of an outboard motor configured in accordance with a preferred embodiment, with various parts sectioned to show greater detail;

FIG. 3 is a schematic diagram of the fuel system and its control parameters including a fuel tank, fuel pumps, a vapor separator and a cooling body of water,

FIG. 4a is a side elevational sectioned view of the vapor separator including a high pressure fuel pump and a vapor separator cooling system configured in accordance with a preferred embodiment;

FIG. 4b is a top cross sectional view of the vapor separator taken along the line B-B in FIG. 4a in accordance with a preferred embodiment;

FIG. 5a is a side elevational sectioned view of the vapor separator including a high pressure fuel pump and another vapor separator cooling system configured in accordance with another preferred embodiment;

FIG. 5b is a top cross sectional view of the vapor separator taken along the line C-C in FIG. 5a in accordance with another preferred embodiment;

FIG. 6a is a side elevational sectioned view of the vapor separator including a high pressure fuel pump and another vapor separator cooling system configured in accordance with another preferred embodiment, and

FIG. 6b is a top cross sectional view of the vapor separator taken along the line D-D in FIG. 6a in accordance with another preferred embodiment;

### DETAILED DESCRIPTION OF THE PREFERRED EMBODIMENT

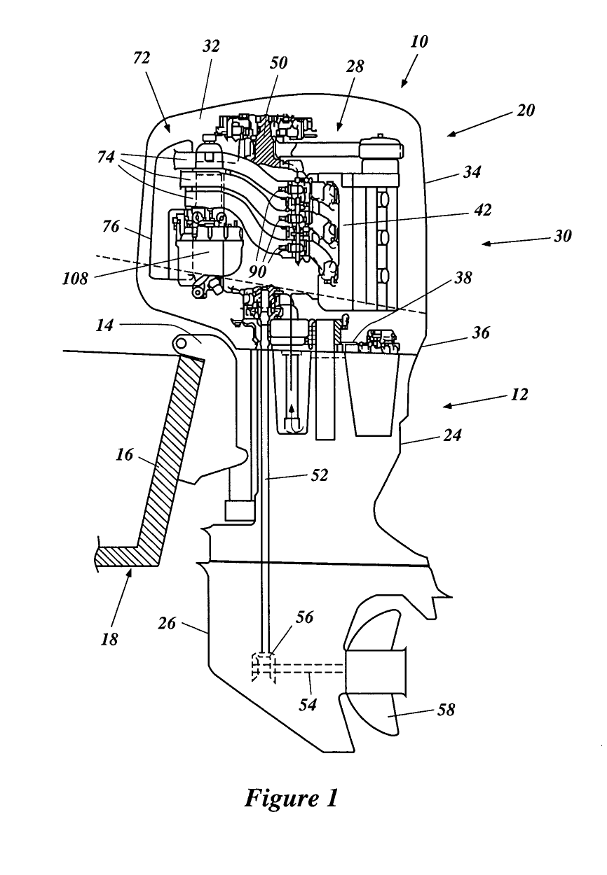

With reference to FIGS. 1-5, an outboard motor 10 includes a drive unit 12 and a bracket assembly 14. The bracket assembly 14 attaches the drive unit 12 to a transom 16 of an associated watercraft 18 and supports a marine propulsion device such as propeller 58 in a submerged position relative to a surface of a body of water.

As used to this description, the terms “forward,” “forwardly,” and “front” mean at or to the side where the bracket assembly 14 is located, unless indicated otherwise or otherwise readily apparent from the context use. The terms “rear,” “reverse,” “backwardly,” and “rearwardly” mean at or to the opposite side of the front side.

The illustrated drive unit 12 includes a power head 20 mounted on top of drive unit 12. The drive unit 12 also includes a drive shaft housing 24 and the lower unit 26. The power head 20 includes an internal combustion engine 28 within a protective cowling assembly 30, which can be made of plastic. The protective cowling assembly 30 typically defines a generally closed cavity 32 in which the engine 28 is disposed. The engine 28 is thereby is generally protected by the cowling assembly 30 from environmental elements.

The protective cowling assembly 30 includes a top cowling member 34 and a bottom cowling member 36. The top cowling member 34 can be detachably affixed to the bottom cowling member 36 by a suitable coupling mechanism to facilitate access to the engine and other related components.

The bottom cowling member 36 has an opening for which an upper portion of an exhaust guide member 38 extends. The exhaust guide member 38 advantageously is made of aluminum alloy and is affixed to the top of the driveshaft housing 24. The bottom cowling member 36 and the exhaust guide member 38 together generally form a tray. The engine 28 is placed on to this tray and can be connected to the exhaust guide member 38. The exhaust guide member 38 also defines an exhaust discharge passage through which burnt charges (e.g., exhaust gases) from the engine 28 pass.

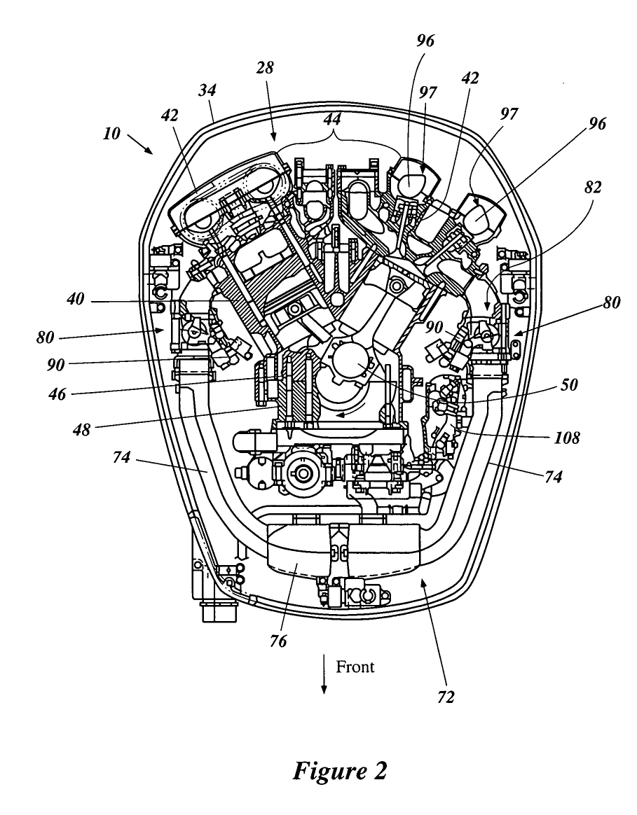

The engine 28 in the illustrated embodiment preferably operates on a four-cycle combustion principle. With reference now to FIG. 2, the engine embodiment illustrated is a DOHC six-cylinder engine having a V-shaped cylinder block 40. The cylinder block 40 thus defines two cylinder banks, which extend generally side by side with each other. In the illustrated arrangement, each cylinder bank has three cylinder bores such that the cylinder block 40 has six cylinder bores in total. The cylinder bores of each bank extend generally horizontally and are generally vertically spaced from one another. This type of engine, however, merely exemplifies one type of engine. Engines having other numbers of cylinders, having other cylinder arrangements (in line, opposing, W, etc.), and operating on other combustion principles (e.g., crankcase compression, two-stroke, diesel, or rotary) can be used in other embodiments.

As used in this description, the term “horizontally” means that members or components extend generally parallel to the water surface (i.e., generally normal to the direction of gravity) when the associated watercraft 18 is substantially stationary with respect to the water surface and when the drive unit 12 is not tilted (i.e., as shown in FIG. 1). The term “vertically” in turn means that proportions, members or components extend generally normal to those that extend horizontally.

A movable member, such as a reciprocating piston, moves relative to the cylinder block 40 in a suitable manner. In the illustrated arrangement, a piston (not shown) reciprocates within each cylinder bore. Because the cylinder block 40 is split into the two cylinder banks, each cylinder bank extends outward at an angle to an independent first end in the illustrated arrangement. A pair of cylinder head members 42 are fixed to the respective first ends of the cylinder banks to close those ends of the cylinder bores. The cylinder head members 42 together with the associated pistons and cylinder bores provide six combustion chambers (not shown). Of course, the number of combustion chambers can vary, as indicated above. Each of the cylinder head members 42 is covered with the cylinder head cover member 44.

A crankcase member 46 is coupled with the cylinder block 40 and a crankcase cover member 48 is further coupled with a crankcase member 46. The crankcase member 46 and a crankcase cover member 48 close the other end of the cylinder bores and, together with the cylinder block 40, define the crankcase chamber.

The crankshaft 50 extends generally vertically through the crankcase chamber and journaled for rotation about a rotational axis by several bearing blocks. Connecting rods couple the crankshaft 50 with the respective pistons in any suitable manner. Thus, a reciprocal movement of the pistons rotates the crankshaft 50.

With reference again to FIG. 1, the driveshaft housing 24 depends from the power head 20 to support a drive shaft 52, which is coupled with crankshaft 50 and which extends generally vertically through driveshaft housing 24. The driveshaft 52 is journaled for rotation and is driven by the crankshaft 50.

The lower unit 26 depends from the driveshaft housing 24 and supports a propulsion shaft 54 that is driven by the driveshaft 52 through a transmission unit 56. A propulsion device is attached to the propulsion shaft 54. In the illustrated arrangement, the propulsion device is the propeller 58 that is fixed to the transmission unit 56. The propulsion device, however, can take the form of a dual counter-rotating system, a hydrodynamic jet, or any of a number of other suitable propulsion devices.

Preferably, at least three major engine portions 40, 42, 44, 46, and 48 are made of aluminum alloy. In some arrangements, the cylinder head cover members 44 can be unitarily formed with the respective cylinder members 42. Also, the crankcase cover member 48 can be unitarily formed with the crankcase member 46.

The engine 28 also comprises an air intake system 72. The air intake system 72 guides air from within the cavity 32 to the combustion chambers. The air intake system 72 shown comprises six intake passages 74 and a pair of intake silencers 76. In the illustrated arrangement, each cylinder bank communicates with three intake passages 74 and one intake silencer 76.

The most downstream portions of the intake passages 74 are defined within the cylinder head member 42 as inner intake passages. The inner intake passages communicate with the combustion chambers through intake ports, which are formed at inner surfaces of the cylinder head members 42. Typically, each of the combustion chambers has one or more intake ports. Intake valves are slidably disposed at each cylinder head member 42 to move between an open position and a closed position. As such, the valves act to open and close the ports to control the flow of air into the combustion chamber. Biasing members, such as springs, are used to urge the intake valves toward their respective closed positions by acting between a mounting boss formed on each cylinder head member 42 and a corresponding retainer that is affixed to each of the valves. When each intake valve is in the open position, the inner intake passage thus associated with the intake port communicates with the associated combustion chamber.

Other portions of the intake passages 74, which are disposed outside of the cylinder head members 42. In the illustrated arrangement, each intake passage 74 comprises a throttle body 80, in which a throttle valve assembly 82 is positioned. The respective intake passage 74 extends forwardly alongside surfaces of the engine 28 on both the port side and the starboard side from the respective cylinder head members 42 to the front of the crankcase cover member 48. The intake passage 74 on the same side extend generally and parallel to each other and are vertically spaced apart from one another.

Each throttle valve assembly 82 preferably includes a throttle valve. Preferably, the throttle valves are butterfly valves that have valve shafts journaled for pivotal movement about generally vertical axis. In some arrangements, the valve shafts are linked together and are connected to a control linkage. The control linkage is connected to an operational member, such as a throttle lever, that is provided on the watercraft or otherwise proximate the operator of the watercraft 18. The operator can control the opening degree of the throttle valves in accordance with operator request through the control linkage. That is, the throttle valve assembly 82 can measure or regulate amounts of air that flow through intake passages 74 through the combustion chambers in response to the operation of the operational member by the operator. Normally, the greater the opening degree, the higher the rate of airflow and the higher the engine speed.

The air within the closed cavity 32 is drawn into the intake silencer 76 and then enters the outer intake passages 74. The air passes through the outer intake passage 74 and the throttle valve assembly 82 regulates the level of airflow.

The engine 28 further includes an exhaust system that routes burnt charges, i.e., exhaust gases, to a location outside of the outboard motor 10. Each cylinder head member 42 defines a set of inner exhaust passages that communicate with the combustion chambers to one or more exhaust ports which may be defined at the inner surfaces of the respective cylinder head members 42. The exhaust ports can be selectively opened and closed by exhaust valves. The construction of each exhaust valve and the arrangement of the exhaust valves are substantially the same as the intake valve and the arrangement thereof, respectively. Thus, further description of these components is deemed unnecessary.

Exhaust manifolds preferably are defined generally vertically with the cylinder block 40 between the cylinder bores of both the cylinder banks. The exhaust manifolds communicate with the combustion chambers through the inner exhaust passages and the exhaust ports to collect the exhaust gas therefrom. When the exhaust ports are opened, the combustion chambers communicate with the exhaust discharge passage through the exhaust manifolds.

In the embodiment of FIG. 1, the driveshaft housing 24 defines an internal section of the exhaust system that leaves the majority of the exhaust gases to the lower unit 26. The internal section includes an idle discharge portion that extends from a main portion of the internal section to discharge idle exhaust gases directly to the atmosphere through a discharge port that is formed on a rear surface of the driveshaft housing 24.

Lower unit 26 also defines an internal section of the exhaust system that is connected with the internal exhaust section of the driveshaft housing 24. At engine speeds above idle, the exhaust gases are generally discharged to the body of water surrounding the outboard motor 10 through the internal sections and then a discharge section defined within the hub of the propeller 58.

A valve cam mechanism preferably is provided for actuating the intake and exhaust valves in each cylinder bank. In the embodiment shown, the valve cam mechanism includes second rotatable members such as a pair of camshafts 96 per cylinder bank. The camshafts 96 typically comprise intake and exhaust camshafts that extend generally vertically and are journaled for rotation between the cylinder head members 42 and the cylinder head cover members 44. The camshafts 96 have cam lobes 97 to push valve lifters that are fixed to the respective ends of the intake and exhaust valves in any suitable manner. Cam lobes repeatedly push the valve lifters in a timely manner, which is in proportion to the engine speed. The movement of the lifters generally is timed by rotation of the camshaft 96 to appropriately actuate the intake and exhaust valves.

The illustrated engine 28 further includes indirect, port or intake passage fuel injection. In a preferred embodiment, the engine 28 comprises fuel injection. The illustrated fuel injection system shown includes six fuel injectors 90 with one fuel injector allotted to each one of the respective combustion chambers. The fuel injectors 90 preferably are mounted on the throttle body 66 of the respective banks.

Each fuel injector 90 has advantageously an injection nozzle directed downstream within the associated intake passage 74. The injection nozzle preferably is disposed downstream of the throttle valve assembly 82. The fuel injectors 90 spray fuel into the intake passages 74 under control of an electronic control unit (ECU) (not shown). The ECU controls the initiation, timing and the duration of the fuel injection cycle of the fuel injector 90 so that the nozzle spray a desired amount of fuel for each combustion cycle.

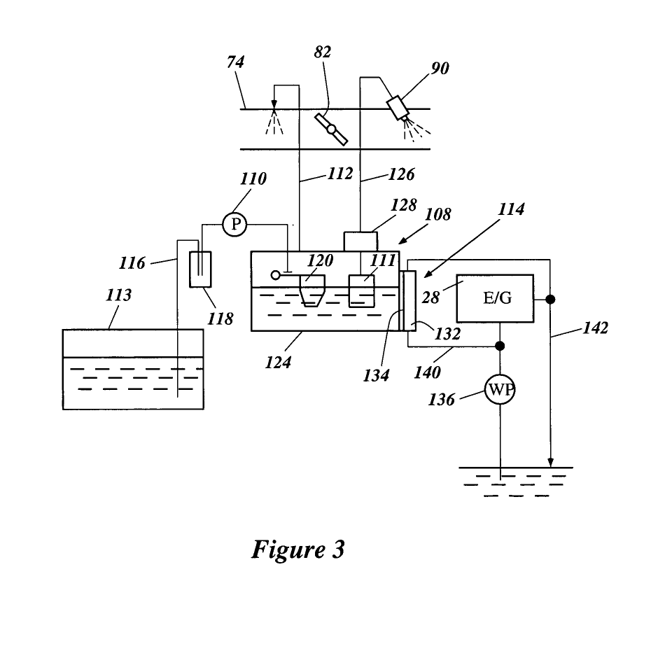

With reference to FIG. 3, a vapor separator 108 preferably is in fluid communication with a fuel tank 113 and a fuel conduit, and can be disposed along the intake passages 74 in one arrangement. The vapor separator 108 separates vapor from the fuel and can be mounted on the engine 28. The vapor separator 108 along with a vapor separator cooling system 109 is described in greater detail below.

The fuel injection system can employ one or a plurality of fuel pumps to deliver the fuel to the vapor separator 108 and to send out the fuel therefrom. More specifically, in the illustrated arrangement, a lower pressure pump 110 pressurizes the fuel toward the vapor separator 108 and the high pressure pump 111, which is disposed within the vapor separator 108, pressurizes the fuel passing out of the fuel separator 108.

A vapor delivery conduit 112 couples the vapor separator 108 with at least one of the intake silencers 76 or at least one of the intake passages 74. The vapor removed from the fuel supply by the vapor separator 108 thus can be delivered to the intake silencer 76 or the intake passage 24 for delivery to the combustion chambers with the combustion air. In other applications, the engine 28 can be provided with a ventilation system arranged to send lubricant vapor to the plenum chamber(s). In such applications, the fuel vapor also can be sent to the plenum chambers via the ventilation system.

The engine 28 further includes an ignition system. Each combustion chamber is provided with a spark plug (not shown), advantageously disposed between the intake and exhaust valves. Each spark plug has electrodes that are exposed in the associated combustion chamber. The spark plugs generate a spark between the electrodes to ignite an air/fuel charge in the combustion chamber according to desired ignition timing maps or other forms of controls.

Generally, during an intake stroke, air is drawn into the combustion chambers through the air intake passages 74 and fuel is mixed with the air by the fuel injectors 90. The mixed air/fuel charge is introduced to the combustion chambers. The mixture is then compressed during the compression stroke. Just prior to a power stroke, the respective spark plugs ignite the compressed air/fuel charge in the respective combustion chambers. The air/fuel charge thus rapidly burns during the power stroke to move the pistons. The burnt charge, i.e., exhaust gases, then is discharged from the combustion chambers during an exhaust stroke.

The illustrated engine further comprises a lubrication system to lubricate the moving parts within the engine 28. The lubrication system is a pressure fed system where the correct pressure is important to adequately lubricate the bearings and other rotating surfaces. The lubrication oil is taken from an oil reservoir (not shown) and delivered under pressure throughout the engine to lubricate the internal moving parts.

The engine 28 may include other systems, mechanisms, devices, accessories, and components other than those described above such as, for example, a cooling system. The crankshaft 50 through a flexible transmitter, such as a timing belt can directly of indirectly drive those systems, mechanisms, devices, accessories, and components.

With reference to FIG. 3, a schematic diagram illustrates a fuel injection system including the vapor separator 108 and an open loop cooling system to cool the engine 28 and the vapor separator 108. Fuel is initial drawn by the low-pressure fuel pump 110 from the fuel tank 113 through a fuel tank supply conduit 116 and passes through a fuel filter 118. The fuel is regulated according to a predetermined amount of fuel measured by a float mechanism 120 before entering a vapor separator tank 124. The fuel is delivered from the vapor separator tank 124 by the high-pressure fuel pump 111 through fuel delivery lines 126 to each fuel injector 90. A fuel pressure regulator 128 regulates the fuel pressure inside the fuel delivery lines 126.

Fuel inside the vapor separator tank 124 is kept at a predetermined temperature through the vapor separator cooling system 114. The vapor separator cooling system 114 can include a detachable heat exchanger 132 that is configured to be detachable from the vapor separator tank 124. When brought into thermal communication with the vapor separator tank 124, the heart exchanger 132 transfers heat away from the vapor separator tank 124. The heat exchanger 132 can use cooling water or other fluids for cooling purposes.

The cooling water used in the heat exchanger 132 can be directed to the heat exchanged 132 through an open-loop cooling system or a closed-loop cooling system. The cooling system 114 can be a separate cooling system designed only to specifically cool the vapor separator tank 124 or the cooling system 114 can be part of another cooling system of the outboard motor 10. For example, the cooling system 114 can be a subpart of a cooling system for cooling the engine 28. Such a cooling system can be an open or closed loop type.

The cooling system 114 can include a heat transfer layer 134 disposed between the heat exchanged 132 and the vapor separator tank 124. The heat transfer later can be configured to allow heat to be effectively transferred from the vapor separator tank 124 to the heat exchanger 132. The heat transfer layer 134 can be made from a material such as, but not limited to copper, silicon grease, or any material with a high thermal conductivity.

With further reference to FIG. 3, a water pump 136 is configured to pump cooling water from an outside source, for example a lake of an ocean, and to deliver the cooling water to the engine 28. Cooling water is delivered to the heat exchanger 132 though a heat exchanger supply conduit 140 and to the engine 28 through other conduits. After transferring heat away from the vapor separator tank 124 through the heat transfer layer 134 and the heat exchanger 132, the water is returned to the body of water through a cooling water return conduit 142.

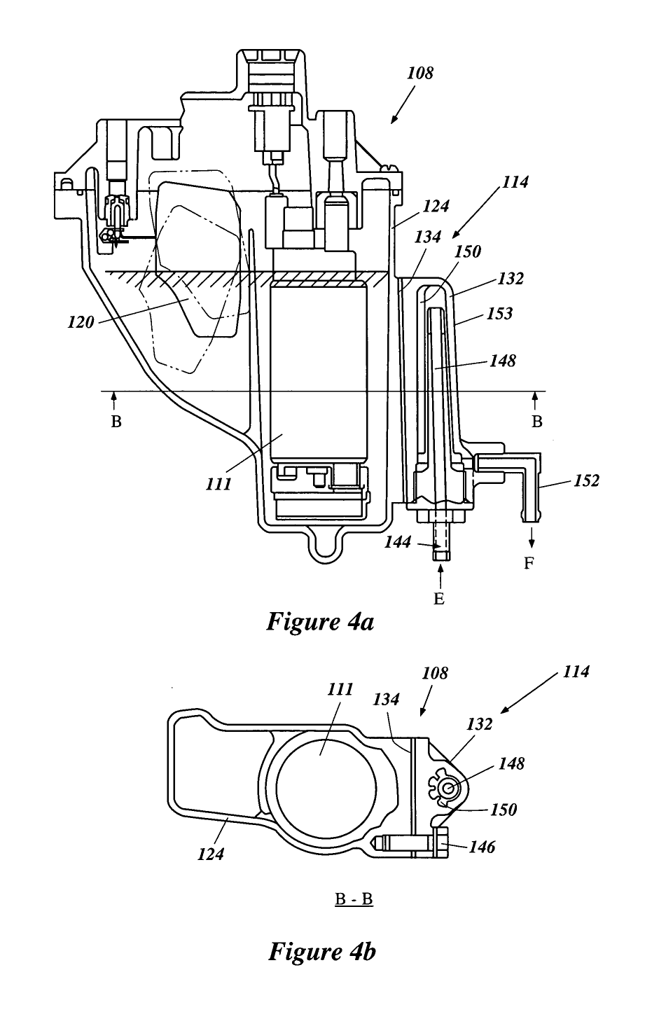

FIG. 4a illustrates a cross sectional side view of a preferred embodiment of the vapor separator 108 and the vapor separator cooling system 114. The detachable heat exchanger 132 is attached to the vapor separator tank 124 through at least one bolt 146 (FIG. 4b). The detachable heat exchanger 132 can also be attached to the vapor separator tank 124 by other attachment systems including, but not limited to, screws, rivets, and/or an epoxy.

The detachable heat exchanger 132 includes a body 153, a coolant supply passage 144, a primary cooling passage 148, a plurality of secondary passages 150, and a coolant exiting passage 152. In this embodiment, the secondary passages are defined, in part, by a recess in the body 153 of the heat exchanger 132 and includes a plurality of ridges extending along one side of the recess. The primary passage 148 is defined by a tubular member extending into the recess. The tubular member is shorter than the recess and thus defines a spillway between the primary passage 148 and the secondary passages 150.

During operation, coolant flows into the supply passage 144, into the primary cooling passage 148 until it reaches the top thereof. Then the coolant flows out of the upper end of the primary passage 148 and spills into the secondary passages 150. As such, heat from the vapor separator tank 124 is transferred to the coolant. The numerous secondary cooling passages 150 provide an increase in surface area to allow more coolant to come in contact with the surface of the secondary-cooling passages 150. This provides an additional advantage in that more coolant coming in contact with more surface area of the secondary cooling passages 150 allows the detachable heat exchanger 132 to remove more heat from the vapor separator tank 124 through the heat transfer layer 134. The coolant exits the detachable heat exchanger 132 through a coolant exiting passage 152 that connects to the coolant water return line 142.

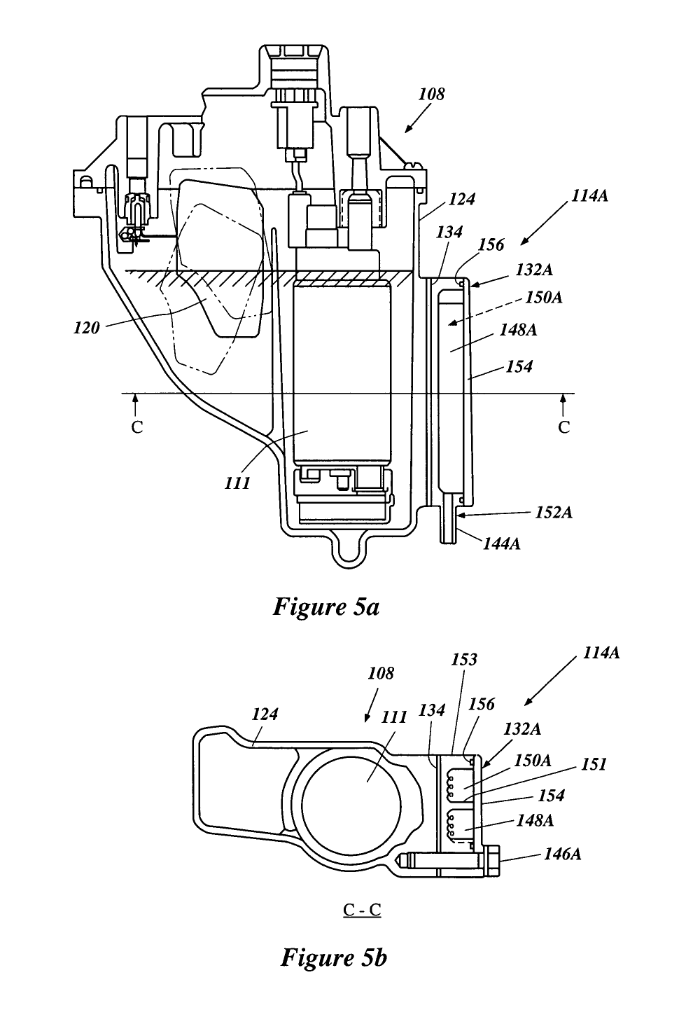

FIG. 5a illustrates a cross sectional side view of a modification of the vapor separator cooling system 114, and is identified generally by the reference number 114A. Components of the cooling system 114A that correspond to the respective components of the cooling system 114 have been identified with the same reference numerals, except that a letter “A” has been added thereto.

With reference to FIG. 5b, the primary cooling passage 148A extends upwardly from the supply passage 144A. At the top of the primary cooling passage 148A, the heat exchanger 132A includes a passage leading to the secondary cooling passage 150A. In the illustrated embodiment, the primary and secondary passages 148A, 150A, are separated by a dividing wall 151, however, other constructions can be used. The coolant exiting passage 152A connects the secondary passage 150A with the return line 142.

The heat exchanger 132A can also be defined by two or more separate pieces. For example, the primary and secondary cooling passages 148A, 150A can be defined initially by open channels or grooves defined in a body member 153, the open portions being closed by a detachable cover member 154. In this embodiment, the bolt 146A can hold the detachable cover 154. Optionally, a gasket or o-ring 156 can be used to seal the cover 154 to the body 153.

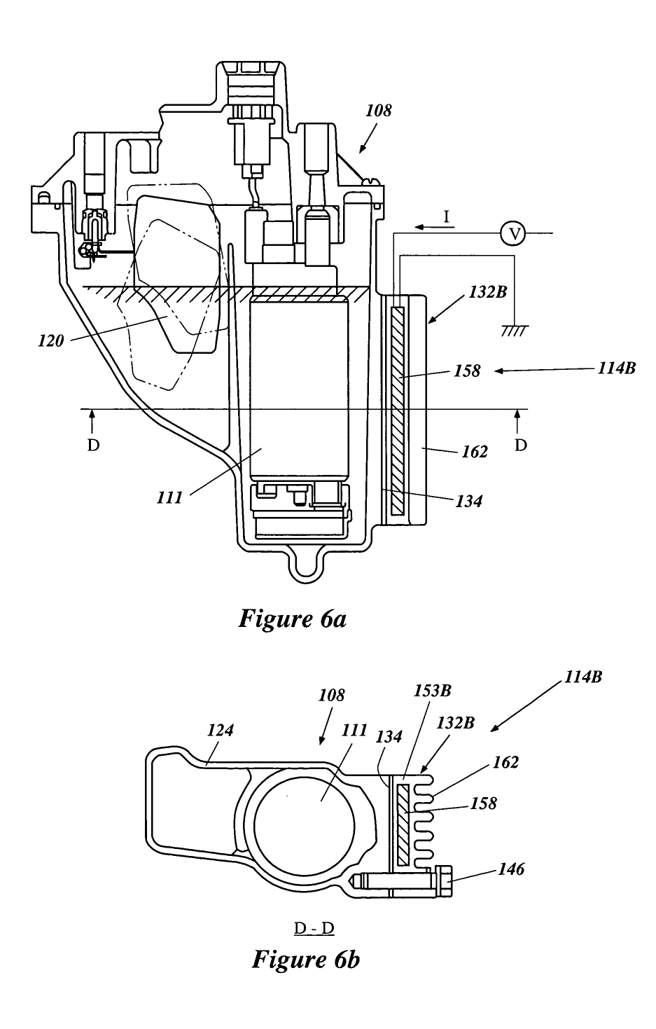

FIGS. 6a and 6b illustrate cross sectional views of yet another modification of the vapor separator cooling system 114, identified generally by the reference numeral 114B. Components of the cooling system 114B that correspond to the respective components of the cooling system 114 have been identified with the same reference numerals, except that a letter “B” has been added thereto.

In this embodiment, the vapor separator tank is cooled using a thermoelectric element 158. For example, but without limitation, the thermoelectric element 158 can be Peltier device. Optionally, the thermoelectric element 158 can be disposed in a body 153B. The thermoelectric element is configured to cool the vapor separator tank 124 by passing a predetermined amount of current (I) through a thermoelectric element that is made up junctions of dissimilar metals. When current is passed through the junctions of dissimilar metals, heat is transferred from one junction to the other. This transfer of heat, called the Peltier effect, cools one junction and transfers the heat from the cooled junction to the other junction.

Additionally, the body 158B can include outer surface features configured to enhance the discharge of heat to the environment. For example, the body 158B can include heat dissipating fins 162 disposed on an outer surface of the body 158B.

The detachable heat exchanger 132B with the incorporated thermoelectric element 158 is attached to the vapor separator tank 124 through at least one bolt 146 (FIG. 6b). The detachable heat exchanger 132B incorporating the thermoelectric element can also be attached to the vapor separator tank 124 by other attachment systems including, but not limited to, screws, rivets, and/or an epoxy.

In the preferred embodiment of FIG. 6a and FIG. 6b the current allows the junction closest to the vapor separator tank 124 to be cooled and transfers the heat from the cooled junction to the junction farthest away from the vapor separator tank 124. The heated junction dissipates the transferred heat from the cooler junction through the heat dissipating fins 162. Thus, the vapor separator is kept cool and the transferred heat is dissipated through the cooling fins 162.

Although the present invention has been described in terms of a certain preferred embodiments, other embodiments apparent to those of ordinary skill in the art also are within the scope of this invention. Thus, various changes and modifications may be made without departing from the spirit and scope of the invention. For instance, not all of the features, aspects and advantages are necessarily required to practice the present invention. Accordingly, the scope of the present invention is intended to be defined only by the claims that follow.

What is claimed is:

1. An engine comprising an engine body defining at least one combustion chamber, a fuel system configured to provide fuel for combustion in the combustion chamber, the fuel system including a vapor separator, and a heat exchanger disposed in thermal communication with the vapor separator and configured to be detachable from the vapor separator.

2. The engine of claim 1, additionally comprising an engine cooling system configured to cool the engine body.

3. The engine of claim 2, wherein the engine cooling system supplies coolant to the heat exchanger.

4. The engine of claim 1, additionally comprising a heat transfer layer positioned between the vapor separator tank and the detachable heat exchanger.

5. The engine of claim 4, wherein the heat transfer layer is made of copper.

6. The engine of claim 4, wherein the heat transfer layer comprises a silicone material.

7. A watercraft propulsion system comprising an engine including an engine body defining at least one combustion chamber, a fuel system including a vapor separator, the vapor separator including a vapor separator tank and a detachable heat exchanger, the detachable heat exchanger including a heat exchanger cooling system configured to transfer heat away from the vapor separator tank.

8. The watercraft engine of claim 7, wherein the heat exchanger comprises a thermoelectric element.

9. The watercraft engine of claim 7, wherein the detachable heat exchanger includes a finned housing to transfer heat to the outside environment.

10. The watercraft engine of claim 7, wherein a heat transfer layer is positioned between the vapor separator tank and the detachable heat exchanger.

11. The watercraft engine of claim 10, wherein the heat transfer layer is made of copper.

12. The watercraft engine of claim 10, wherein the heat transfer layer is made of a silicone material.

13. An engine comprising an engine body defining at least one combustion chamber, a fuel system configured to provide fuel for combustion in the combustion chamber, the fuel system including a vapor separator, and a heat exchanger disposed in thermal communication with the vapor separator, the heat exchanger including means for detaching the heat exchanger from the vapor separator.
